(19) United States
(12) Patent Application Publication
(10) Pub. No.: US 2014/0325558 A1
(43) Pub. Date: Oct. 30, 2014

(54) Managing Advertisements Based On Public Records

(71) Applicant: Cable Television Laboratories, Inc., Louisville, CO (US)

(72) Inventor: Deborah S. Fitzgerald, Superior, CO (US)

(73) Assignee: Cable Television Laboratories, Inc., Louisville, CO (US)

(21) Appl. No.: 14/257,963

(22) Filed: Apr. 21, 2014

Related U.S. Application Data
(60) Provisional application No. 61/817,215, filed on Apr. 29, 2013.

(51) Int. Cl. G06Q 30/02; H04N 21/458; H04N 21/81; H04N 21/234

(52) U.S. Cl. CPC G06Q 30/0269; H04N 21/23424; H04N 21/458; H04N 21/812
USPC 725/34; 705/14.66

(57) ABSTRACT

The insertion of addressable or other dynamically determinable advertisements during playback or other access to content is contemplated. The contemplated advertisement insertion may rely upon public records to identify activities, events, engagements and other metrics related to user undertakings. The public records may then be used to facilitate pre-scheduled or otherwise adjust advertisements previously associated with accessed content.

### CROSS-REFERENCE TO RELATED APPLICATIONS

This application claims the benefit of U.S. provisional Application No. 61/817,215 filed Apr. 29, 2013, the disclosure of which is incorporated in its entirety by reference herein.

### TECHNICAL FIELD

The present invention relates to managing advertisements shown or otherwise interfaced when accessing content, such as but not necessary limited to selecting advertisements according to information contained within public records.

### BACKGROUND

Advertisements may be used by service providers, multiple system operators (MSOs), Internet service providers (ISPs), cellular service providers and any number of other entities providing content or other transmissible media to consumers in order to generate revenue or to accomplish some other goal. One non-limiting aspect of the present invention contemplates improving the selection of such advertisements based on public records.

### BRIEF DESCRIPTION OF THE DRAWINGS

FIG. 1 illustrates a system for advertising in accordance with one non-limiting aspect of the present invention.

FIG. 2 illustrates a flowchart of a method for advertising in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

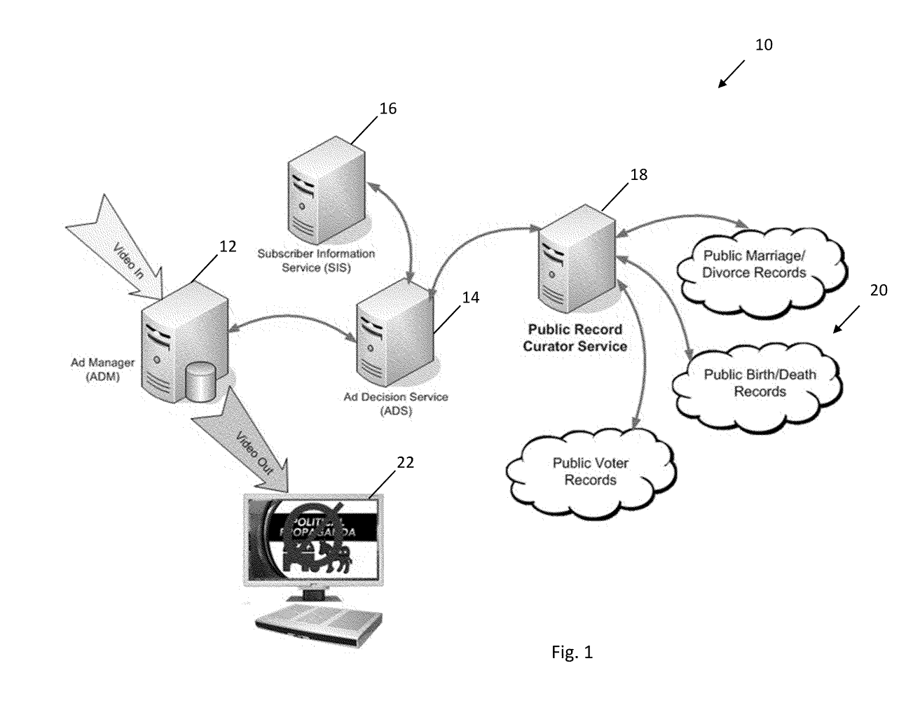

FIG. 1 illustrates a system 10 for advertising in accordance with one non-limiting aspect of the present invention. The system 10 is described with respect to an exemplary configuration utilizing nomenclature consistent with the Society of Cable Telecommunications Engineers (SCTE), Digital Program Insertion—Advertising Systems Interfaces (SCTE 130) specification, the disclosure of which is hereby incorporated by reference in its entirety. Of course, the present invention is not necessarily so limited and fully contemplates facilitating advertising according to other specifications and standards, including according to the digital program insertion (DPI) disclosed in U.S. patent application Ser. No. 11/962,449, entitled Method and System of Device Level Program Insertion, the disclosure of which is hereby incorporated by reference in its entirety, which includes facilitating dynamic advertisement insertion according to OpenCable Application Platform (OCAP) Specification v1.1, Cable Television Laboratories, Inc., the disclosure of which is hereby incorporated in its entirety. The advertisement selection processes described herein may also be beneficial in cooperation with or by facilitating operations contemplated in U.S. patent application Ser. No. 13/855,669, entitled Coupon Code Redemption, the disclosure of which is hereby incorporated by reference in its entirety.

One non-limiting aspect of the present invention proposes the concept of using public records to determine which addressable advertisements are shown in a household. For example, if every eligible voter in a household has submitted an early vote in an election, the MSO can discontinue sending election advertisements to that household by using public voting records to make this determination. The present invention may be used as an extension of the addressable advertising concept that is currently deployed by cable today. In the SCTE 130 model, when an advertisement is about to play, an Ad Manager System (ADM) 12 asks an Ad Decision Server (ADS) 14 what ad should be played. This decision is based on a number of factors, including information about the subscriber.

The concept proposed here integrates that Ad Decision Server 14 not only with the Subscriber Information Service (SIS) 16 tasked with tracking/utilizing non-public records to facilitate advertising, but also with a server 18 that provides public record information. Examples of this public record information could be: information about the voting records of eligible voters in the household; marriage or divorce licenses recently acquired in a household; birth or death information recently attributed to a member of a household, etc. The use of this public information or other public information may be beneficial in enabling a service provider to make a big win with their customers by blocking unwanted ads (such as political ads once every eligible voter in the household has voted). This has many benefits, including: encourages eligible voters to cast their mail-in ballots early (would increase voter participation); customers would love this feature from their operators, and therefore love their company (customer retention); and operators could replace political ad spots with local ad spots and potentially increase revenue.

This invention could be applied to linear video, on-demand video, and even TVE (TV Everywhere) IP video streaming or any other type of electronically transmissible media. There is the possibility to increase revenue with local ad spots, but it may impact overall revenue lost from the political campaigns. Another option would be to offer this as a service by the operator for which the subscriber would pay extra during the campaign period. In the case of using public voting records as an example, during the election campaign period, and before the household voters have voted, this information could be used to target specific advertisements toward voters. Public voting records may include information about party affiliations and when the voters have voted such that political advertisements in line with the party affiliations may be selected and/or political advertisements may be replaced with non-political advertisements if the voter has already voted, optionally with ads not being blocked until early voting is available. The present invention can be expanded beyond just the public voting records. It can use other public records such as marriage, divorce, birth, death, or even the fact that a subscriber has a new address as important information in selecting the most appropriate advertisement to deliver to the consumer.

The provider or a third party may provide the server 18 that curates the public information about its subscribers, users, consumers, etc. by accessing a variety of public records 20, and the addressable ad system 14 utilizes this information effectively to make intelligent ad selections. The public information/data, commonly referred to herein as public records, may be differentiated from metadata or other metrics collected through web browsing, television viewing history/preferences or other mechanisms where user activities are being monitored according to engagement with a accessing device 22, such as but not necessarily limited to a tablet, a second screen application, a television, a set-top box (STB) and the like. Public records contain information that is generally freely available, but not currently used in a context such as what is contemplated here for the benefit of the video subscriber. The public records, although freely available, are not all in one place or necessarily easy to access. The public record curator service 18 provides a standard way of accessing the public information to be used in the ad decision process. The public records 20 may be generated by the users transmitting data or other information to the public curator service, such as through and interaction with the accessing device 22, e.g., submitting a confirmation message indicating a casting of an absentee ballot, recordation of a birth record, etc., or may be generated through the standard governmental processes, such as submitting a mail-in ballot in an election, registering to vote, and obtaining a marriage license.

Different algorithms may be applied to different types of public records 20. For example, if the ad is a political ad prior to an election, the server will base the decision on the number of eligible voters in the household who have submitted early ballots. An example algorithm for managing political advertisements:

WHEN ad spot becomes available:

IF subscriber has opted in for political ad bypass:

Subscriber management system queries public record service:
For this household, IF all eligible voters in the household have

submitted early votes:

Play alternate ad

ELSE:

Play political ad

If the ad is related to a baby item, the server 14 may base the ad on birth information including the date of the birth. In this example, the subscriber management system queries the public record server without requiring an opt-in flag. The thought here is that there are several child-related ads and the appropriate one will be selected based on age of the child.

WHEN child-related ad spot becomes available:

Subscriber management system queries public record service and determines there is a child in the household:

IF birth date of child < 3 months ago

Play newborn ad

ELSE IF birth date of child < 12 months ago

Play chunky baby ad

ELSE IF birth date of child < 24 months ago

Play toddler ad

ELSE

Play generic ad

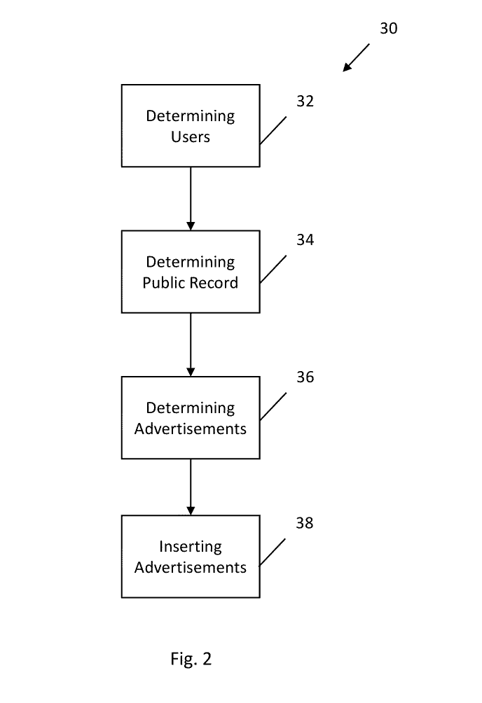

FIG. 2 illustrates a flowchart 30 of a method for managing advertising in accordance with one non-limiting aspect of the present invention. The method may be embodied in a non-transitory computer-readable medium having a plurality of instructions operable with a processor of the accessing device 22 or other device having capabilities sufficient to facilitate managing advertising in accordance with the operations contemplated herein. The method is described with respect to facilitating advertising during a television program through digital program insertion or other techniques where advertisements transmitted separately to the accessing device may be overlaid or otherwise inserted in place of advertisements transmitted with or otherwise already embedded in the television program. This is done for exemplary non-limiting purposes as the present invention fully contemplates inserting the advertisements at a location upstream from the accessing device for inclusion within the television signaling, such as at a headend, as well as facilitating advertising in other forms of media besides a television program, such as within a webpage, a audio track, a second screen application, etc.

Block 32 relates to determining one or more users associated with the television program being accessed. The user may be determined at an individual level or as a collection, such as multiple users within a household or associated with the common subscription. The identification of the user may be sufficient to facilitate determining one or more public records in Block 34. Block 36 relates to determining advertisements to be inserted in Block 38. The advertisements may be selected based on the public records and inserted in place of advertisements transmitted with the television program to facilitate adjusting the scheduled or programmed advertisements according to data included within the public records, e.g., playing a non-political advertisement in place of a political advertisement if the user or other entity associated with the accessing device has already voted in an election scheduled for advertisement within the television program.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of facilitating advertising according to public records comprising:
determining a content being transmitted to a device associated with a consumer in a manner sufficient to enable advertisements to be inserted during playback;
determining a first plurality of advertisements specified within a schedule for insertion during playback of the content;
prior to the first plurality of advertisements being inserted during playback of the content:
i) determining a public record associated with the consumer;
ii) determining if the public record is of at least a first type or a second type;
iii) removing a first advertisement of the first plurality of advertisements from the schedule if the public record is of the first type; and
iv) keeping the first advertisement in the schedule if the public record is of the second type.

2. The method of claim 1 further comprising determining the public record to be a voting record of the consumer, including determining the voting record to be the first type if the consumer has already voted in an election identified within the first advertisement and to be the second type if the consumer has not already voted in the election.

3. The method of claim 2 further comprising determining the consumer to have already voted in the election if the consumer has requested an absentee ballot.

4. The method of claim 3 further comprising determining whether the consumer has requested the absentee ballot based on whether the device has transmitted an absentee ballot confirmation message to a public record curator.

5. The method of claim 2 further comprising determining the consumer to be a plurality of users associated with a household such that the voting record is determined to be the first type if each of the plurality of users has already voted in the election and to be of the second type if any one or more of the plurality of users has not voted in the election.

6. The method of claim 1 further comprising determining the public record to be a birth record associated with the consumer, including determining the birth record to be the first type if indicative of having a child less than three months old and to be the second type if having no child or a child older than three months.

7. The method of claim 6 further comprising replacing the first advertisement in the schedule with a second advertisement such that a second advertisement is scheduled in place of the first advertisement, the second advertisement not being one of the first plurality of advertisements.

8. The method of claim 7 further comprising selecting the second advertisement to be a baby advertisement if the birth record indicates the consumer to have a child between three months and twelve months old.

9. The method of claim 8 further comprising selecting the second advertisement to be a toddler advertisement if the birth record indicates the child to be older than twelve months.

10. The method of claim 6 further comprising replacing the first advertisement in the schedule with a second advertisement such that a second advertisement is scheduled in place of the first advertisement.

11. The method of claim 10 further comprising transmitting the second advertisement to the device after the device receives the first plurality of advertisements, the device locally performing digital program insertion to facilitate insertion of at least the second advertisement during playback of the content.

12. The method of claim 1 further comprising querying a public record curator server for the public record, the public record curator server include a human-machine interface (HMI) sufficient for the consumer to input data used to generate the public record.

13. The method of claim 1 further comprising determining the public record to be one of a marriage record, a divorce record, a birth record, a death record or a voter record.

14. The method of claim 13 further comprising:
determining the public record to be the first type;
replacing the first advertisement with a second advertisement such that the second advertisement plays in place of the first advertisement during playback of the content; and
selecting the second advertisement to be:
i) a marriage advertisement if the marriage record is determined;
ii) a divorce advertisement if the divorce record is determined;
iii) a birth advertisement if the birth record is determined;
iv) a death advertisement if the death record is determined; and
v) a voter advertisement if the voter record is determined.

15. A non-transitory computer-readable medium having a plurality of instructions operable with a processor of a television or a set-top box (STB) to facilitate inserting advertisements during playback of a television program, the plurality of instructions being sufficient for:
querying a public record curator for a public record associated with a user of the television or STB;
determining a first advertisement to be inserted during playback of the television program as a function of the public record; and
facilitating insertion of the first advertisement during playback of the television program.

16. The non-transitory computer-readable medium of claim 15 further comprising instructions sufficient for displaying a graphical user interface (GUI) to the user prior to querying the public record curator service and receiving through the GUI data to be transmitted to the public record curator to facilitate generating the public record.

17. The non-transitory computer-readable medium of claim 15 further comprising instructions sufficient for selecting the first advertisement to be a non-political advertisement in the event the public record indicates the user to have already voted in an election associated with a second advertisement, the second advertisement being previously scheduled for playback during the television program through the television or STB.

18. The non-transitory computer-readable medium of claim 17 further comprising instructions sufficient for selecting the first advertisement to be a newborn baby advertisement in the event the public record indicates the user to have registered a birth certificate within the last three months.

19. The non-transitory computer-readable medium of claim 15 further comprising facilitating insertion of the first advertisement by replacing at the television or STB a second advertisement transmitted within the signaling used to carry the television program to the television or STB for playback.

20. A system for facilitating insertion of advertisements during playback of content comprising:
a public record curator service configured to store public records associated with a plurality of users, including the following public records: a marriage record, a divorce record, a birth record, a death record and a voter record;
a subscriber information service configured to store non-public records associated with the plurality of users;
an ad decision service configured to process the public records and the non-public records in order to facilitate determining a plurality of advertisements to be inserted during playback of a content; and
an ad manager configured to facilitate insertion of the plurality of advertisements during playback of the content.
